(19) United States
(12) Patent Application Publication
(10) Pub. No.: US 2008/0116024 A1
(43) Pub. Date: May 22, 2008

(54) Vibration damper with adjustable damping force

(75) Inventors: Steffen Heyn, Niederwerrn (DE); Thomas Manger, Wasserlosen-Kaisten (DE); Andreas Sieber, Schweinfurt (DE); Bernd Zeissner, Gaibach (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/974,806

(22) Filed: Oct. 16, 2007

(30) Foreign Application Priority Data
Oct. 17, 2006 (DE) 10 2006 048 913.6

(51) Int. Cl. F16F 9/34

(52) U.S. Cl. 188/322.13

(57) ABSTRACT

A vibration damper with adjustable damping force, including a valve body and an actuator. The actuator causes the valve body to move toward a valve seating surface against a nonlinear elastic force, thereby creating a characteristic curve, which describes the function “open valve cross section-versus-energy input to the actuator” and which has at least two ranges with different slopes.

### BACKGROUND OF THE INVENTION

1. Field of the Invention

The invention relates to a vibration damper with adjustable damping force.

2. Description of the Related Art

A damping valve with adjustable damping force is known from U.S. Pat. No. 6,000,508. The damping valve comprises a main-stage valve and a pilot-stage valve, which is shown on an enlarged scale in FIGS. 3 and 4. To obtain an inflection in the curve of the current versus the valve cross section as shown in FIG. 1 of the descriptive part of this invention, it is already known that the valve body 73 can have a double-conical valve surface, as shown on an enlarged scale in FIG. 2. The current-versus-valve cross section characteristic is determined as a function of the angle between the valve surfaces 1 and 2 and the longitudinal axis. When the section of the characteristic determined by the valve surface 2 is to be made even flatter, as shown in broken line, the angle of the valve surface 2 must be even smaller. Certain limits are imposed on this valve design, however. First, manufacturing tolerances responsible for deviations of the diameter of the valve surface 2 and of the diameter of the valve seating surface have certain effects. Even the very smallest deviations spoil the desired damping force characteristic, i.e., the curve which describes how the cross-sectional area of the valve changes with the current. There is also the problem that the valve surface 2 can become jammed against the valve seating surface, with the result that the valve spring can no longer return the valve body back into an open position after it has reached, for example, the maximum closing position.

### SUMMARY OF THE INVENTION

An object of the present invention is to solve the problem known from the prior art relating to the current-valve cross section characteristic.

According to the invention, the problem is solved in that the valve body is adjusted by the actuator against a nonlinear elastic force.

The great advantage of the invention is that the shape of the valve seat is no longer the key factor which determines the “open valve cross section-versus-energy input” function, which means that the valve body can be designed with a much larger degree of freedom. It becomes possible to select a shape for the valve body which is easy to manufacture and insensitive to manufacturing tolerances.

The nonlinear elastic force is determined by at least two valve springs. Depending on the required characteristic, additional valve springs can also be used.

The force of the actuator acts against the resultant force of the valve springs. This leads to the possibility that at least one of the minimum of two valve springs will go into action after the valve body has traveled a defined distance and that a nonlinear characteristic curve will be obtained.

In a first variant, the nonlinear elastic force is determined by at least two parallel-connected valve springs.

In addition, a first valve spring, which acts on the valve body, is provided in a first housing part section of the adjustable damping valve. This spring is axially supported on a supporting element, which is mounted on a first housing part section, and loads the valve body axially against a stop surface on this housing part section. The second valve spring is provided in a second housing part section. The advantage is that the valve body, the first valve spring, and the support element form a preassembled structural unit.

The second spring is required to act over only a relatively small part of the stroke of the valve body. This valve spring can therefore be designed advantageously as a disk spring.

In an alternative variant, the valve body is actuated in two-way fashion by at least one spring where the elastic force has a nonlinear characteristic in at least one actuation direction.

To achieve the desired characteristic behavior with simplest possible means, the minimum of one spring rises from the valve body during the stroke of the valve.

There is also the possibility that at least two series-connected springs could be used, where a switching element controls the point at which one of the springs goes into action.

To achieve a strict separation between the elastic forces of the valve springs, the switching element is loaded by one of the springs against a stop and rises from the stop during the course of an opening movement of the valve body.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is to be explained in greater detail on the basis of the following description of the figures:

FIG. 1 shows a characteristic curve of the current versus the open valve cross section; Iₘₐₓ means each of the damping valves shown in FIGS. 2-4 has a maximum open valve cross section when no current is supplied; Iₘᵢₙ means each of the damping valves shown in FIGS. 5-8 has a minimum open valve cross section when no current is supplied;

FIG. 2 shows a cross-section view of a valve body of the adjustable damping valve known from the prior art;

FIGS. 3-4 show cross-section views of an embodiment with an additional parallel-acting valve spring;

FIGS. 5-6 show cross-section views of an embodiment with an additional series-connected valve spring; and

FIGS. 7a-8c show cross-section views of an embodiment with an additional parallel-acting valve spring.

### DETAILED DESCRIPTION OF THE PRESENTLY PREFERRED EMBODIMENTS

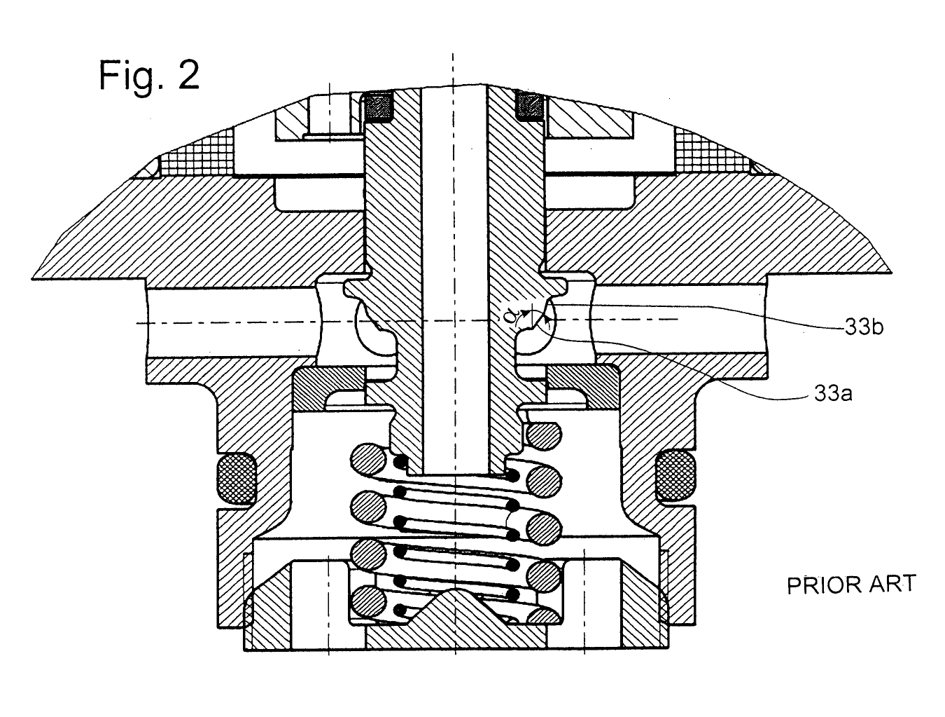

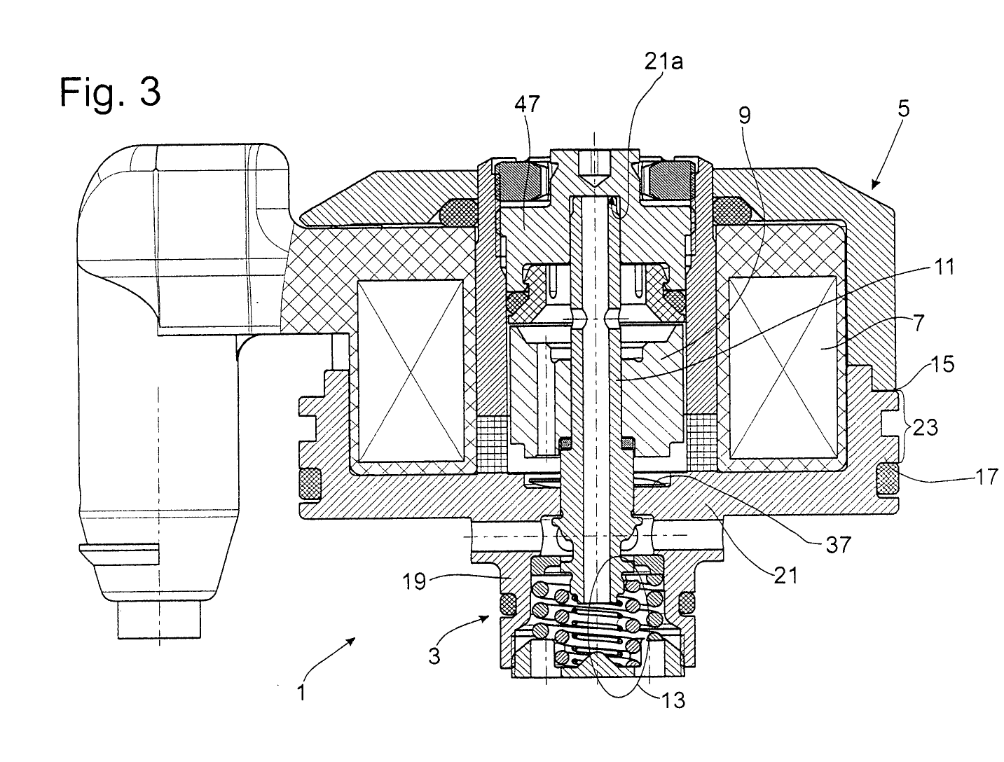

FIG. 3 shows a pilot valve 3 with an actuator 5 for a damping valve 1 with adjustable damping force. A main-stage valve which can be combined with this pilot-stage valve 3 is already known from the previously cited DE 196 24 897, FIG. 2, and represents part of this description of the figures.

The actuator 5 comprises a coil body 7, which can exert an adjusting force on a tubular valve body 11 by way of an armature 9 against the force of a valve spring arrangement 13. A damping valve housing 15 has a cup-like base body 17 with a tubular extension or a first housing section 19, in which the valve spring arrangement 13 is mounted. The coil body 7 is located in a second housing section 23, separated from the first housing section 19 by a bottom part 21. In the no-load state of the actuator, the valve spring arrangement 13 loads or pushes the valve body 11 against a stop surface 21a on the damping valve housing 15 or on an adjusting screw 47. When current is sent to the coil body 7, the distance between the ring-shaped armature 9 and the top surface of the bottom part 21 decreases.

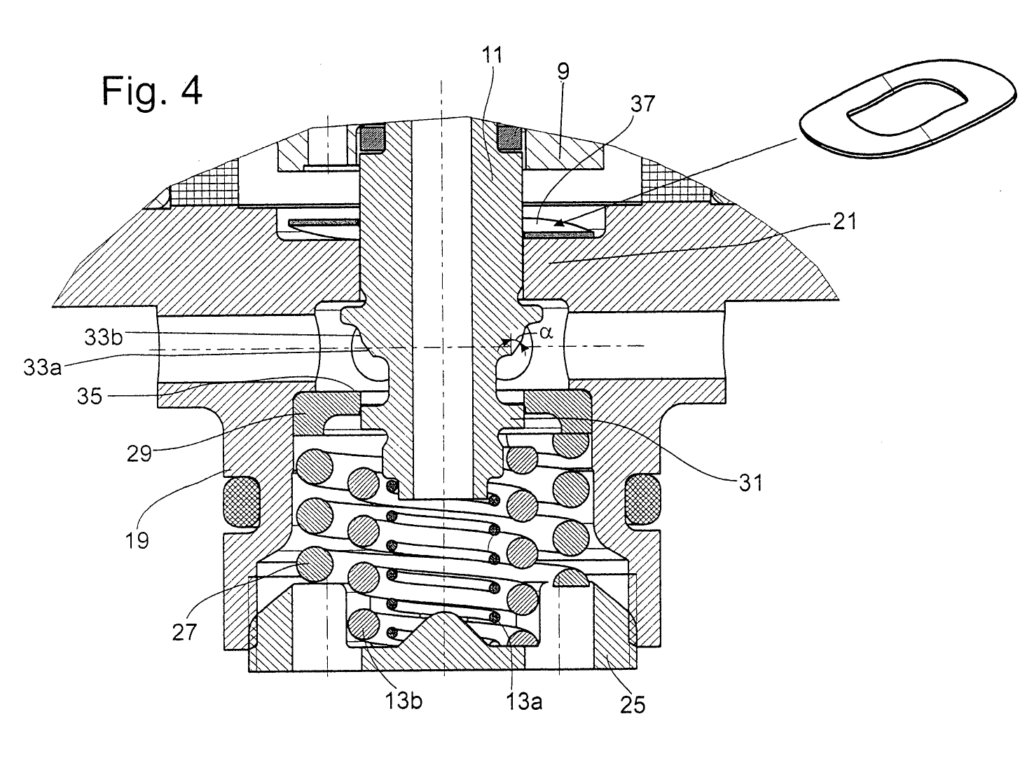

FIG. 4 shows the first housing section 19 with the valve springs 13a, 13b of the valve spring arrangement 13 on a larger scale. At the end opposite the bottom part 21, the tubular extension 19 has a threaded-in or screwed-in disk 25, which serves as a support element for the two valve springs 13a, 13b. A third, outer spring 27 has the purpose of holding a valve seating disk 29 axially in position in the tubular extension 19 even against the adjusting force of the actuator 5. The outer spring 27 also serves to lock the screwed-in disk 25 in the receiving thread.

An inner valve spring 13a with a weak pushing force acts over the entire stroke of the valve body 11, and when the current fails, it moves the valve body 11 into the valve position shown, in which the damping valve follows a desired fail-safe characteristic. In the fail-safe position, the outer valve spring 13b provided for normal operating conditions has no contact with a first force-transmitting flange 31.

The seating surface relevant for normal operation of the pilot-stage valve 3 extends at two stepped angles to the longitudinal axis of the valve body 11, so that first and second valve surfaces 33a, 33b are present. In general, the invention can also be applied effectively to a stepless valve surface.

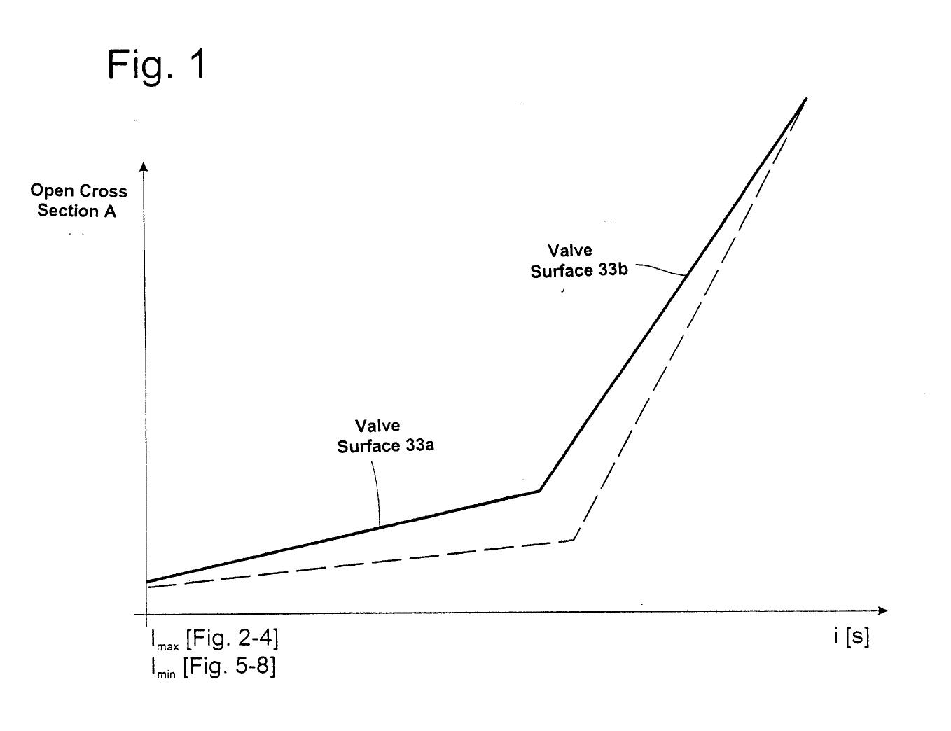

When only a small amount of current is sent to the actuator 5, the first valve surface 33a approaches the top surface of the valve seating disk 29, which carries the valve seating surface 35, against the force of the outer valve spring 13b. The gap between the valve surface 33a, 33b and the valve seating surface 35 determines the open cross section A according to the portion of the characteristic curve with the steeper slope (see FIG. 1). The larger the angle α between the longitudinal axis and the valve surface 33a, 33b, the steeper this part of the characteristic curve.

After a defined distance, which is associated with the supply of a larger amount of current to the actuator 5, a second valve spring 37 goes into action so that a nonlinear elastic force acts on the valve body 11 against the force of the actuator 5 over the entire distance traveled. In this exemplary embodiment, the two valve springs 13b, 37 are connected in parallel. The second valve spring 37, which is designed as a disk spring, rests on the bottom part 21 of the cup-shaped damping valve housing 17 and acts on a force-transmitting flange, which is formed by the ring-shaped armature 9. As soon as the second valve spring 37 goes into action, the spring rates, i.e., the spring forces, of the two valve springs 13b, 37 are added to each other. As the amount of power being supplied continues to increase in linear fashion, the actuating force also increases linearly, but the force against which it acts increases discontinuously (i.e., non-linearly) as a result of the addition of the spring rates of the two valve springs 13b, 37. The ratio between power input and valve spring force has therefore decreased, so that the power-versus-open cross section A characteristic becomes flatter. The use of a nonlinear elastic force for the normal operation of the actuator 5 disconnects the contour of the valve surfaces 33a, 33b from the power-versus-open cross section A characteristic. It can be quite effective to use a stepped valve surface contour, but it is no longer necessary for this contour to be related to the power-versus-open cross section A characteristic. There is therefore greater freedom of design with respect to the contours of the valve surface on the valve body 11.

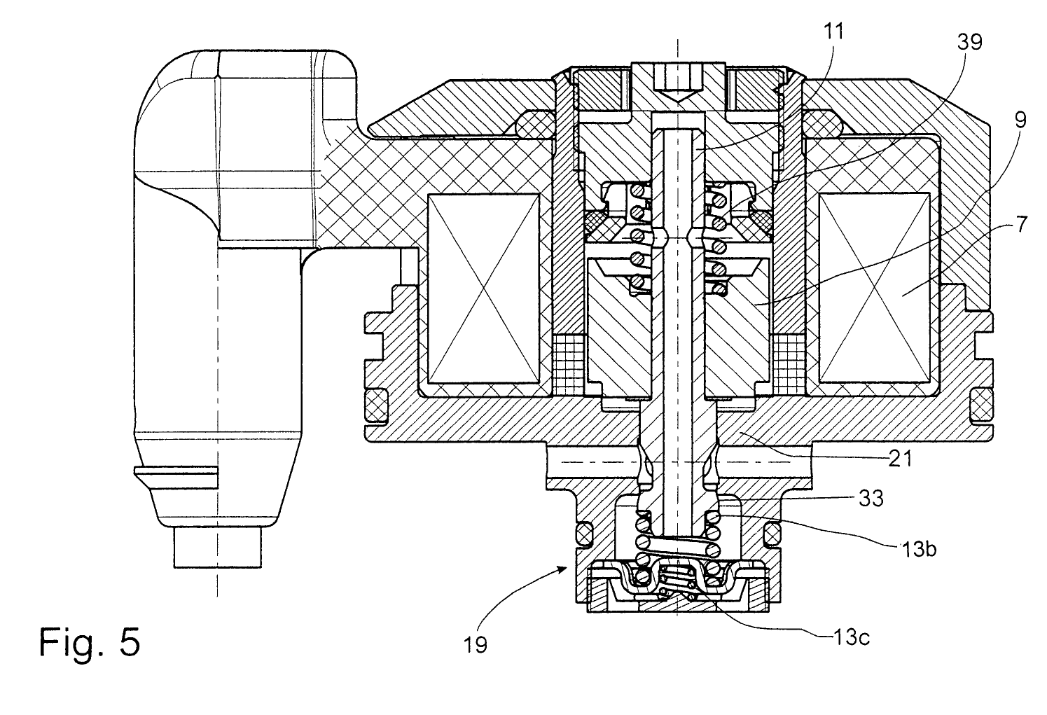

FIG. 5 shows an actuator 7, 9 with the same basic features as those of the actuator according to FIG. 3. The difference is that the valve body 11 and the armature 9 are loaded or pushed in a floating manner in the axial direction between a valve spring 39 near the armature 9 and two valve springs 13b, 13c in the tubular extension 19 of the housing. Another difference from the embodiment according to FIG. 3 is that the valve surface 33 is located on a surface of the force-transmitting flange 31 and the valve seating surface is on a surface of the bottom part 21.

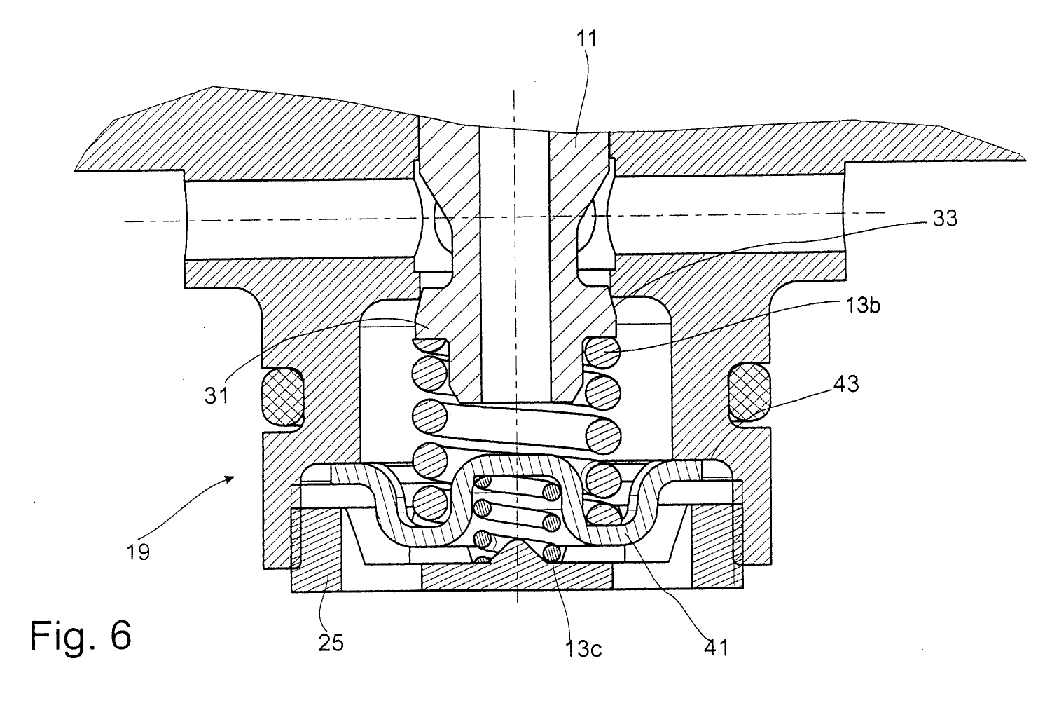

FIG. 6 shows part of the valve body 11 with the minimum of one valve surface 33 on an enlarged scale. A first valve spring 13c, which acts in the closing direction of the valve body 11, is supported on the screwed-in disk 25, which could be held in position on the housing in some other way, and presses a switching element 41 against a stop 43 in the tubular housing extension 19. A second valve spring 13b acting in the closing direction is loaded or pushed independently of the stroke position of the valve body 11 at all times between the top surface of the switching element 41 and the force-transmitting flange 31 on the valve body 11. The spring rate of the second valve spring 13b is greater than the spring rate of the first valve spring 13c, but the pushing or resultant force of the first valve spring 13c is greater than the pushing or resultant force of the second valve spring 13b. FIG. 6 shows the feature that the valve body 11 can also have a single valve surface 33.

When current is applied, the resultant force produced by the armature-side spring 39 and the adjustable force of the actuator 7, 9 acts against the two valve springs 13b, 13c. Because the pushing force of the first valve spring 13c is greater than the pushing force of the second valve spring 13b, only the second valve spring 13b is compressed, and meanwhile the valve surface 33 rises from the valve seating surface of the bottom part 21. The switching element 41 remains in its position on the stop 43. As more current is supplied up to a defined level, which corresponds to the inflection point of the characteristic curve of the current versus the open cross section A, the pushing force of the armature-side spring 39 decreases in linear fashion, and the first valve spring 13c starts to produce the same pushing force as the second valve spring 13b. As the current continues to increase, the switching element 41 moves away from the stop 43, so that the actuator 7, 9 now acts against the series circuit consisting of the two valve springs 13b, 13c, which means that a much smaller total spring rate is now present. If we assume that the current being supplied to the actuator 7, 9 increases in linear fashion, a defined increase in current now causes the valve body 11 to travel a much longer distance than that which the valve body 11 traveled before the switching element 41 was moved out of its stop position. Overall, therefore, the valve springs have a nonlinear spring characteristic.

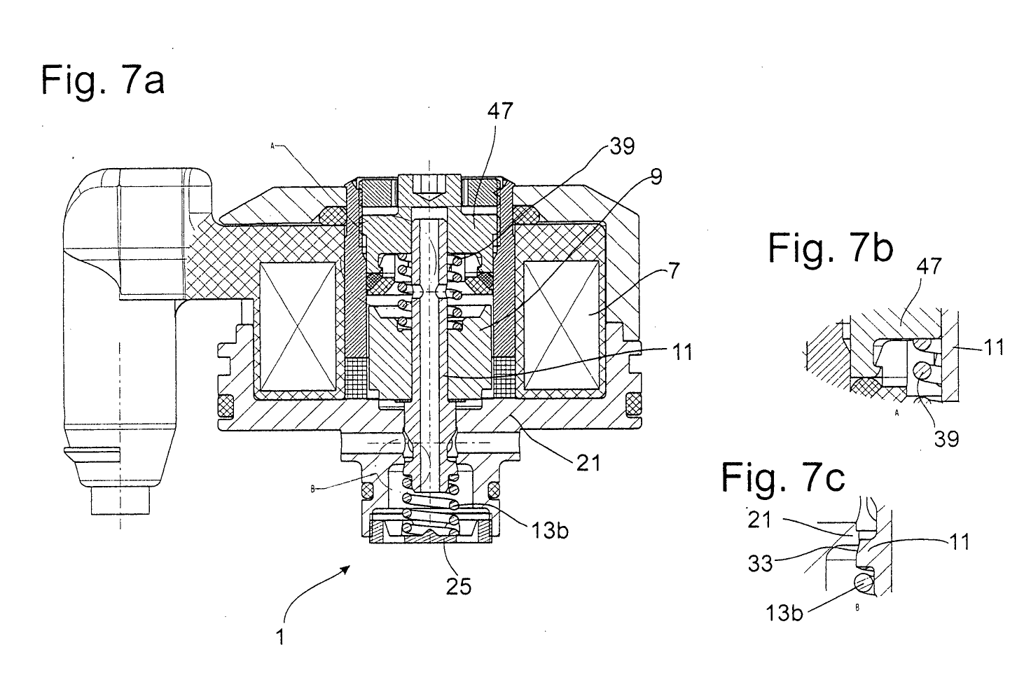

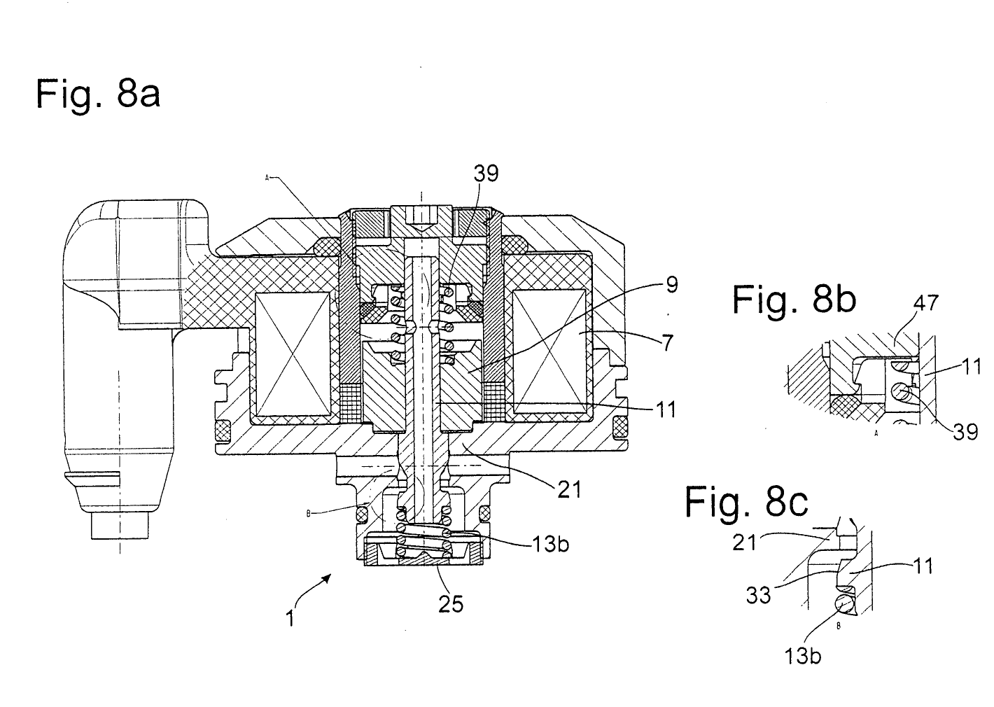

FIGS. 7a-8c show another embodiment of the adjustable damping valve 1, which is similar to the functional principle of FIGS. 5 and 6. FIGS. 7a-7c are intended to show the currentless state of the actuator 7, 9. The armature-side valve spring 39 and the valve spring 13b, which is located between the screwed-in disk 25 and the valve body 11, push the valve body 11, which thus occupies its closed position or a nearly closed stroke position, as illustrated in FIG. 7c. It can be seen from FIGS. 7a and 7b that the final turns of the armature-side valve spring 39 rest against the adjusting screw 47 and rest against the armature 9 and is therefore under compression.

When current is supplied to the actuator 7, 9, the forces resulting from the armature-side valve spring 39 and the adjustable force of the actuator 7, 9 act against the valve body-side valve spring 13b, and the valve body 11 is pushed against the force of the valve body-side valve spring 13b. As soon as a certain current level is reached, the armature-side valve spring 39 is completely relaxed; that is, the distance between the top surface of the armature 9 and the inside surface of the adjusting screw 47 is greater than the relaxed length of the armature-side valve spring 39. This stroke length determines the inflection point of the current-versus-open cross section curve A, because, as more current is supplied to the actuator 7, 9, only this magnetic force is left to act against the pushing force of the valve body-side valve spring 13b.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An adjustable damping valve, comprising:
a housing having a valve seating surface;
a valve body in the housing;
a spring applying a force on the valve body;
an actuator configured to exert an adjusting force causing an operating movement of the valve body toward the valve seating surface against the force of the spring,
wherein the housing and the valve body define an open valve cross section of a throttle therebetween, and
wherein the adjustable damping valve exhibits a characteristic curve describing the open valve cross section of the throttle relative to energy input to the actuator, the characteristic curve comprising two ranges with different slopes.

2. The adjustable damping valve of claim 1, wherein the spring comprises at least two valve springs creating the characteristic curve comprising two ranges with different slopes.

3. The adjustable damping valve of claim 2, wherein one of the at least two valve springs acts on the valve body only after the valve body moves a pre-determined distance toward the valve seating surface from an initial position at which the actuator exerts no adjusting force.

4. The adjustable damping valve of claim 2, wherein the at least two valve springs are parallel-connected.

5. The adjustable damping valve of claim 4, wherein the housing comprises a first housing section, a second housing section, and a supporting element mounted on the first housing section, the at least two valve springs comprising a first valve spring disposed in the first housing section and supported axially against the supporting element, and a second valve spring disposed in the second housing section.

6. The adjustable damping valve of claim 5, wherein the second valve spring comprises a disk spring.

7. The adjustable damping valve of claim 1, wherein the valve body is movable in a direction toward the valve seating surface and a direction away from the valve seating surface, the adjustable damping valve exhibiting the characteristic curve when the valve body moves in at least one of the directions.

8. The adjustable damping valve of claim 7, wherein the spring comprises at least two valve springs, at least one of which expands when the valve body moves in the direction toward the valve seating surface.

9. The adjustable damping valve of claim 7, wherein the spring comprises at least two valve springs which are series-connected, the adjustable damping valve further comprising a switching element configured to determine when one of the at least two valve springs starts to act on the valve body.

10. The adjustable damping valve of claim 9, wherein the housing further comprises a stop, the switching element being loaded by the one of the at least two valve springs against the stop, the one of the at least two valve springs acting on the valve body when the switching element moves away from the stop.
